(19) United States
(12) Patent Application Publication
(10) Pub. No.: US 2002/0188525 A1
(43) Pub. Date: Dec. 12, 2002

(54) Online ordering method

(76) Inventor: Masahiro Terada, Asaka-shi (JP)

Correspondence Address: BIRCH STEWART KOLASCH & BIRCH, PO BOX 747, FALLS CHURCH, VA, 22040-0747, US

(21) Appl. No.: 10/162,876

(22) Filed: Jun. 6, 2002

(30) Foreign Application Priority Data
Jun. 8, 2001 (JP) 2001-174238
May 29, 2002 (JP) 2002-156135

(51) Int. Cl. G06F 17/60

(52) U.S. Cl. 705/26

(57) ABSTRACT

The online ordering method is provided which allows a user to receive a recording medium containing images, etc. from a media preparation service client and place orders for services such as printing of images contained in the recording medium with a service provider via a communications network. The method includes: a step in which a service provider receives information about image service, payment information of a cost, identification information of a recording medium, and images from a media preparation service client and records them in an account database and image database; a step in which a personal computer of a user sends identification information specific to the user and image service order information to the service provider; and a step in which the service provider receives the user-specific identification information and order information from the user, reads service usage information for the appropriate user from the account database, and reads an appropriate image from the image database and provides image service to the appropriate user if it judges that usage charges for the order are within the amount paid by the media preparation service client.

### BACKGROUND OF THE INVENTION 1. Field of the Invention

The present invention relates to an online ordering method and more particularly, relates to an online ordering method of ordering commodities via a communications network such as the Internet. 2. Description of the Related Art

Systems have been known in which orders are placed for prints by sending, via the Internet, pictures taken by a digital camera to a server machine which provides print services.

Also, systems have been known in which the host of a wedding or the like distributes gift coupons and catalogs to the guests, who later select a commodity from the catalog and have it delivered.

However, since image data for printing is generally large in volume, it takes a client machine tens of minutes to send an image to be printed to the server machine which provides print services.

Possible methods of payment include payment in exchange for goods or online settlement using a credit card number. In either case, the client who places an order makes the payment. For example, when a host of a wedding wants to distribute prints to the guests, there is no ordering method in which guests place orders and the host pays for them, and this is inconvenient.

### SUMMARY OF THE INVENTION

The present invention has been achieved in view of the above circumstances. Its object is to provide an online ordering method which allows a user to receive a recording medium containing images or the like from a media preparation service client and place orders for services such as printing of images contained in the recording medium with a service provider via a communications network.

To attain the above object, the present invention is directed to an online ordering method in which a user receives a recording medium containing images and user-specific identification information from a media preparation service client and the user places an order for a service such as printing of images contained in the recording medium with a service provider via a communications network, the above described online ordering method using an online ordering system which comprises: the recording medium containing images and received by the user together with the user-specific identification information from the media preparation service client; a user's communications terminal capable of transmitting and receiving information to/from an image service provider's server via the communications network; and the service provider's server which is capable of transmitting and receiving information to/from the above described user's communications terminal via the communications network, is equipped with an account database that records the above described user-specific identification information and image service usage information by associating them with each other, and provides an image service, the above described online ordering method comprising: a step in which the service provider's server receives information about image service, information to the effect that the cost of the image service will be paid, identification information of the recording medium, and the images to be handled by the service, from the media preparation service client who has made the request to prepare the recording medium; a step in which the service provider's server records the above described received information about service and identification information of the recording medium in the account database by associating them each other; a step in which the service provider's server records the above described received identification information of the recording medium and the images to be handled by the service in an image database by associating them with each other; a step in which the user's communications terminal transmits the above described user-specific identification information to the above described service provider's server; a step in which the user's communications terminal transmits order information about a service such as printing of images recorded in the recording medium or the like to the above described service provider's server; a step in which the service provider's server receives the user-specific identification information from the user's communications terminal; a step in which the service provider's server receives the order information from the user's communications terminal; a step in which the service provider's server reads from the above described account database the image service usage information for the user who corresponds to the above described received identification information; and a step in which the service provider's server reads an appropriate image from the image database and provides image service to the appropriate user based on the above described received order information if it judges that service charges calculated based on the above described received order information and the above described image service usage information are within the amount paid by the media preparation service client.

In an online ordering system, this invention allows the user to place orders for services such as printing of images contained in the recording medium with a service provider via a communications network because it includes a step in which the service provider's server receives information about image service, information to the effect that the cost of the image service will be paid, identification information of the recording medium, and the images to be handled by the service, from the media preparation service client who has made the request to prepare the recording medium; a step in which the service provider's server records the received information about service and identification information of the recording medium in the account database by associating them with each other; a step in which the service provider's server records the received identification information of the recording medium and the images to be handled by the service in an image database by associating them with each other; a step in which the user's communications terminal transmits the user-specific identification information to the service provider's server; a step in which the user's communications terminal transmits order information about a service such as printing of images recorded in the recording medium or the like to the service provider's server; a step in which the service provider's server receives the user-specific identification information from the user's communications terminal; a step in which the service provider's server receives the order information from the user's communications terminal; a step in which the service provider's server reads from the account database the image service usage information for the user who corresponds to the received identification information; and a step in which the service provider's server reads an appropriate image from the image database and provides image service to the appropriate user based on the received order information if it judges that service charges calculated based on the received order information and the image service usage information are within the amount paid by the media preparation service client.

To attain the above object, the present invention is also directed to an online ordering method in which a user receives a recording medium containing images and user-specific identification information from a media preparation service client and the user places an order for a service such as printing of images contained in the recording medium with a service provider via a communications network, the above described online ordering method using an online ordering system which comprises: the recording medium containing images and received by the user together with the user-specific identification information from the media preparation service client; a user's communications terminal capable of transmitting and receiving information to/from an image service provider's server via the communications network; and the service provider's server which is capable of transmitting and receiving information to/from the above described user's communications terminal via the communications network, is equipped with an account database that records the above described user-specific identification information and image service usage information by associating them with each other, and provides an image service, the above described online ordering method comprising: a step in which the user's communications terminal transmits the above described user-specific identification information to the above described service provider's server; a step in which the user's communications terminal transmits order information about a service such as printing of images recorded in the recording medium or the like to the above described service provider's server; a step in which the service provider's server receives the user-specific identification information from the user's communications terminal; a step in which the service provider's server receives the order information from the user's communications terminal; a step in which the service provider's server reads from the above described account database the image service usage information for the user who corresponds to the above described received identification information; and a step in which the service provider's server overwrites the user's image service usage information based on the above described received order information; a step in which the service provider's server provides service to the appropriate user based on the above described received order information; and a step in which, based on the above described overwritten service usage information, the service provider's server transmits billing information concerning usage charges to the communications terminal on the side of the media preparation service client who has made the request to prepare the recording medium or on the side of the user.

In an online ordering system, this invention allows the user to place orders for services such as printing of images contained in the recording medium with a service provider via a communications network because it includes a step in which the user's communications terminal transmits the user-specific identification information to the service provider's server; a step in which the user's communications terminal transmits order information about a service such as printing of images recorded in the recording medium or the like to the service provider's server; a step in which the service provider's server receives the user-specific identification information from the user's communications terminal; a step in which the service provider's server receives the order information from the user's communications terminal; a step in which the service provider's server reads from the account database the image service usage information for the user who corresponds to the received identification information; and a step in which the service provider's server overwrites the user's image service usage information based on the received order information; a step in which the service provider's server provides service to the appropriate user based on the received order information; and a step in which, based on the overwritten service usage information, the service provider's server transmits billing information concerning usage charges to the communications terminal on the side of the media preparation service client who has made the request to prepare the recording medium or on the side of the user.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a diagram showing physical distribution and information flow in services according to the present invention;

FIG. 2 is a diagram showing flow of information exchanged between a user and a service provider;

FIG. 3 is a diagram showing information recorded in an account database;

FIG. 4 is a diagram showing information recorded in an image database;

FIG. 5 is a diagram showing a prepaid purchase order submitted by a media preparation service client to the service provider;

FIG. 6 is a flowchart of service order processing performed on a user's communications terminal; and

FIG. 7 is a flowchart of service order processing performed by a service provider's server.

### DETAILED DESCRIPTION OF THE PREFERRED EMBODIMENTS

A preferred embodiment of an online ordering method according to the present invention will be described in detail below according to the accompanying drawings.

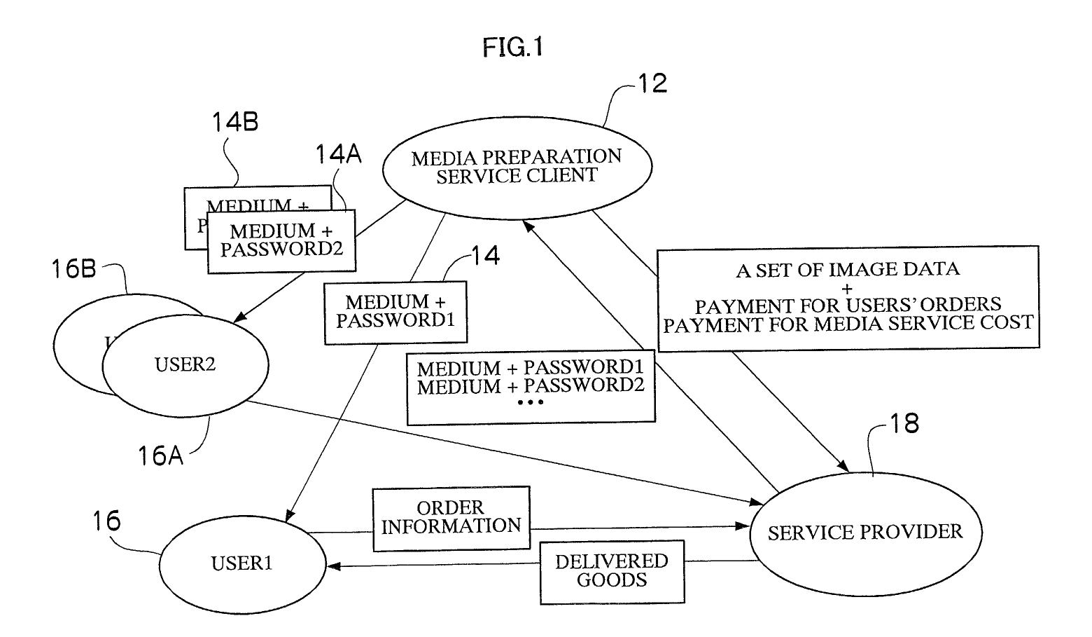

FIG. 1 shows physical distribution and information flow in services according to the present invention.

As shown in the drawing, a media preparation service client 12 (person who makes a request to prepare recording media), who is the host of a wedding or the like distributes recording media 14, 14A, 14B, . . . each containing images picked up in a wedding ceremony or the like, an ID (service information about image services) unique to each medium (shown as a medium in the drawing) and a password (user-specific identification information) associated with the media ID to users 16, 16A, 16B, and so on when the ceremony is over. The recording medium 14 here is a CD-ROM, DVD, MO, high-capacity floppy disk (Zip), or the like. The recording medium 14 may contain a list or catalog of commodities sold or delivered.

A processing unit (communications terminal, client machine) such as a personal computer 80 owned by each of the users 16, 16A, 16B, etc. is capable of exchanging, via a communications network such as the Internet, order information, an ID, a password, and other information with a server of a service provider 18 that prints and delivers images. The server of the service provider 18 is capable of exchanging, via a communications network such as the Internet, image data handled by services, payment information for users' orders, information to the effect that the cost of image services will be paid, payment information for media service cost, an ID or other identification information (this may be identification information which represents a type of image service) unique to recording media, and a password or other similar information with the media preparation service client 12.

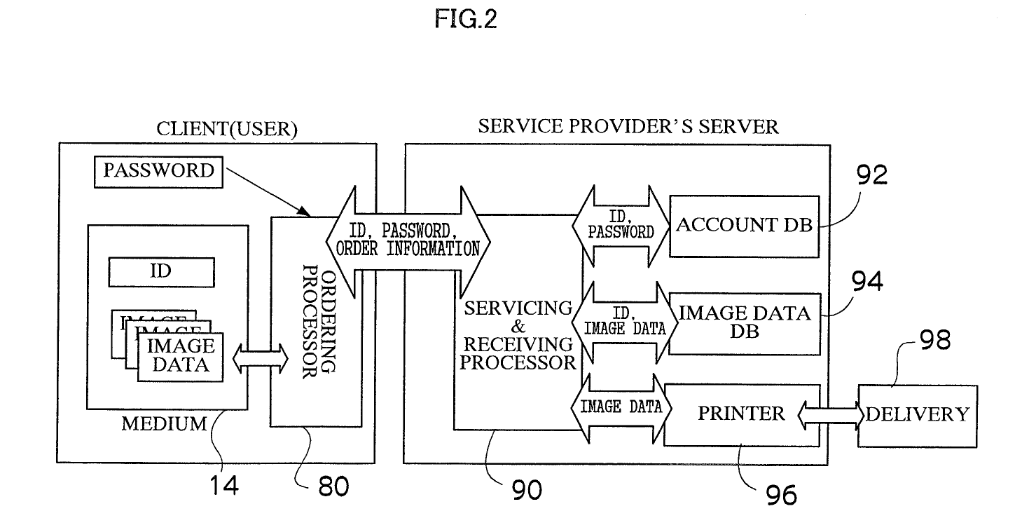

FIG. 2 shows flow of information exchanged between the user 16 and service provider 18.

As shown in the drawing, the user 16 is provided with the recording medium 14 (medium) containing an ID as well as with a personal computer 80 (an ordering processor) for mounting the recording medium 14 and placing an order to print images recorded in the recording medium 14.

The service provider 18 is provided with a server 90 which exchanges information with the user 16 or media preparation service client 12 via the communications network; an account database 92 which stores the ID, account, password, and other information recorded in the recording medium distributed to the user 16 or the like, by associating them with one another; an image database 94 which stores the ID of the recording medium 14 and images stored in the recording medium 14 by associating them with each other; a printer 96 which prints out image data requested by the user 16 or the like; and means of delivery 98 which delivers the prints to the user 16 or the like who wanted to purchase them.

The server 90 is capable of recording information in databases such as the account database 92 and the image database 94 as well as reading recorded information from the databases. Also, the server 90 is capable of outputting image data and print conditions to the printer 96 and instructing it to print images. The account database 92 and the image database 94 may be stored in a communications terminal of the media preparation service client 12.

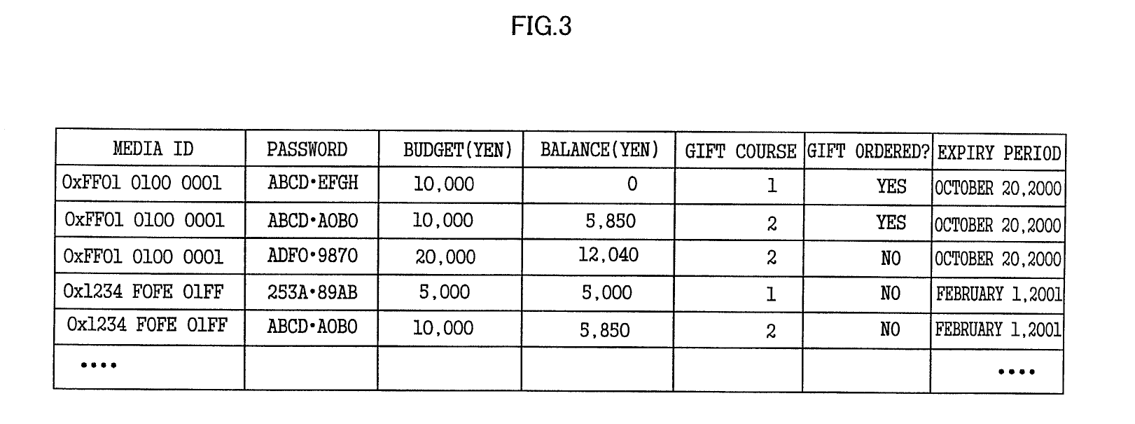

FIG. 3 shows media IDs, passwords specific to users, and other information recorded in the account database, being associated with one another.

As shown in the drawing, the account database 92 stores the IDs of the recording media 14 (media ID) which contain images taken at a wedding or the like, passwords of individual users, service budgets available to individual users, the amounts left in the service budgets, selected gift courses, information as to whether or not a gift has been ordered yet, expiry dates of services, service usage information, and other information by associating them with one another.

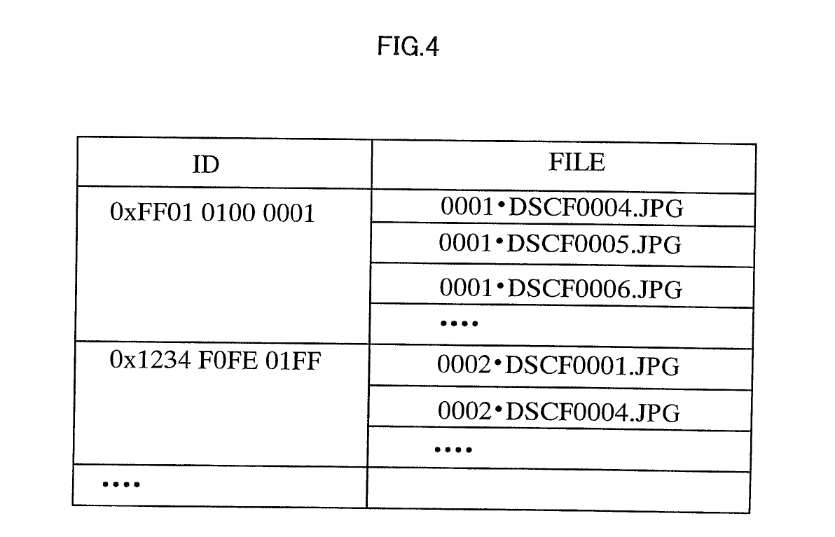

FIG. 4 shows information recorded in the image database.

As shown in the drawing, the image database 94 stores the IDs of recording media 14 (media IDs) and image files recorded in the recording media 14, by associating them each other.

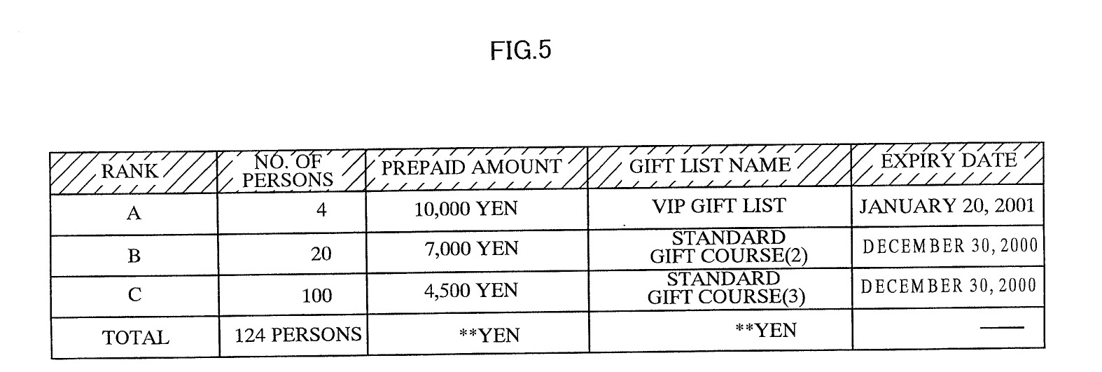

FIG. 5 shows a prepaid purchase order submitted by the media preparation service client 12 to the service provider 18.

As shown in the drawing, the prepaid purchase order (order sheet) contains, for example, ranking information classified according to prepaid amounts, the number of users 16 belonging to each rank, prepaid amounts, names of gift lists provided to users 16 or the like, and expiry dates of services by associating them with one another.

The host of the wedding (the media preparation service client 12) photographs scenes during the wedding reception with a digital camera and edits and saves the photographed images. After the end of the wedding reception, the saved image data and the prepaid purchase order shown in FIG. 5 are handed to the service provider 18. In so doing, the communications terminal of the media preparation service client 12 may transmit to the server 90 of the service provider 18 information to the effect that costs required (service charges) for the image service will be paid, before paying. The service charges to be paid here may be, for example, the total amount of basic service rates and prepaid amounts specified in the prepaid purchase order plus the total amount of gifts.

Regarding the payment of the service charges, the service provider 18 may bill the media preparation service client 12 after the expiry date of the service according to the actual amounts ordered. In this case, the server 90 reads, from the account database 92, the image service usage information for the user 16 who corresponds to the ID received from a personal computer 80 and overwrites the service usage information for the appropriate user 16, including usage charges, based on received order information. Then, the server 90 provides appropriate services to the appropriate user 16 based on the received order information and sends billing information on the usage charges to the personal computer 80 on the side of the media preparation service client who has made the request to prepare the recording medium or on the side of the user 16.

Some distinction may be made in the range of items available for ordering according to the password described above. The range of items available for ordering may be listed for each user 16, for example, in terms of monetary amounts or points on an ordering screen of application software. Any order which exceeds the range presented to the user 16 may be rejected. Also, the range of items available for ordering may be specified when passwords are created or may be changeable after the distribution of the recording media 14.

Upon obtaining the above information, the server 90 of the service provider 18 registers new accounts in the account database 92 according to the entries of the prepaid purchase order described above. Then, it creates and registers passwords for all the users by associating them with the IDs of the recording media 14 and sets usage information, including a prepaid amount, balance, gift list, and expiry date of application, in relation to each password. Also, the server 90 of the service provider 18 records the image data received from the media preparation service client 12 in the image database 94 by associating them with the IDs of the recording media 14.

Orders may be closed out after the specified expiry date described above. The images which have been recorded in the image database 94 of the server 90 at the request of the media preparation service client 12 may be deleted just as orders are closed out or after a predetermined retention period.

The media preparation service client 12 requests the service provider 18 to prepare the recording media 14 for the number of users 16. The server 90 of the service provider 18 reads the requested image data, media IDs, application software of an image browser, application software for ordering images, gift lists (list of information about items which can be ordered and each of which is identified by a unique number), and other information from the account database 92 and image database 94 and records them in the recording media 14. Regarding the application software, different application software may be prepared for different requesting parties 12 or its content may vary somewhat for the user 16, . . .

When the above information has been recorded on the recording media 14 (CD-R or the like), a label on which a rank and password are indicated is affixed to each of the prepared recording media 14 to complete the recording media 14. The completed recording media 14 are delivered to the media preparation service client 12. At the end of the wedding reception, the host hands the recording media 14 to the guests (users 16) before they go home.

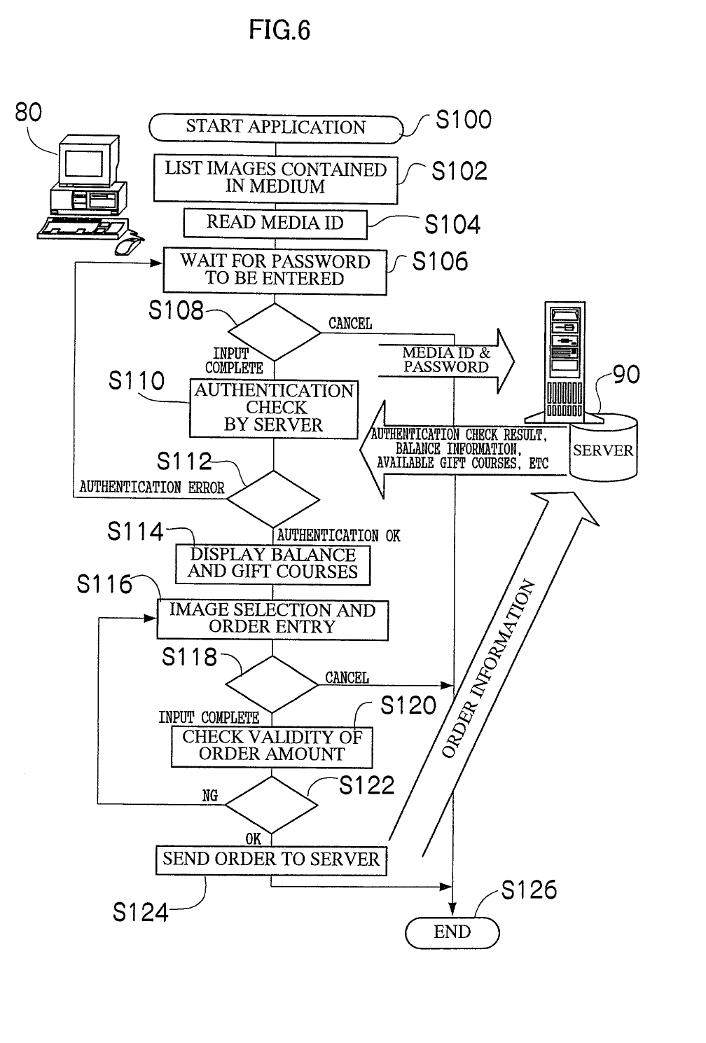

FIG. 6 shows a flowchart of service order processing performed on the user's communications terminal.

When the users 16 come home after the event such as a wedding, they mount the recording medium 14 in a processing unit (communications terminal) such as the personal computer 80 and view images taken at the wedding or the like and recorded in the recording medium 14. If they want any image to be printed, they starts up application software in S100 (Start application) to start communicating with the server of the service provider 18 via a communications network such as the Internet. Then, the processing performed by the information processor of the personal computer 80 goes to S102 (List images contained in medium). The application software may be recorded in the recording media 14 together with the image data.

In S102, the personal computer 80 displays a list of the images recorded in the recording medium 14, on its display device. In S104 (Read media ID), the personal computer 80 reads the ID (media ID) recorded in the recording medium 14. In S106 (Wait for password to be entered), the personal computer 80 displays a message on the display device, prompting the user 16 to enter the user-specific password which is indicated in the label on the recording medium 14, and waits for the user 16 to enter his/her password.

In the next S108, the personal computer 80 judges whether the user 16 has entered his/her password via an input device of the personal computer 80. If the user 16 enters information about his/her intention to cancel processing of a print order or the like instead of entering his/her password, the processing branches to S126 (End) to terminate the order processing. If it is judged in S108 that the user 16 has entered his/her password, the processing goes to S110 (Authentication check by server). The password may be prerecorded in the recording medium 14. In that case, the personal computer 80 will read the password automatically from the recording medium 14.

In S110, the personal computer 80 starts to exchange information with the server 90 via the communications network such as the Internet and sends the media ID and password to the server 90. The personal computer 80 receives the results of authentication check on the media ID and password from the server 90 and displays them on the display device.

In S112, a judgment is made based on the received authentication check results. If the ID and password do not match and information about unsuccessful authentication is received from the server 90, the processing performed by the information processor returns to S106. If the ID and password do match and information about successful authentication is received from the server 90, the processing performed by the information processor goes to S114 (Display balance and gift courses), in which the personal computer 80 displays the information about the amount left in the service budget, information about available gift courses, etc. received from the server 90 on the display device.

When the display processing described above is done, the processing performed by the information processor of the personal computer 80 goes to S116 (Image selection and order entry), where the information processor displays information on the display device, prompting the user to select desired images and order prints, select gifts as required from a list, etc. Then, the processing goes to the next S118. The images displayed here for the user 16 may be prerecorded in the recording medium 14 or obtained as thumbnail images or the like from the server 90.

In S118, the information processor makes judgments based on the information entered by the user 16 via the input device of the personal computer 80. If the user 16 enters information about his/her intention to cancel order processing instead of selecting images and ordering prints, cancellation information is sent to the server 90 and the processing branches to S126 (End) to terminate the order processing. If it is judged in S118 that the user 16 has entered information which indicates that he/she has selected images, ordered prints, and/or selected gifts, the processing goes to S120 (Check validity of order amount).

In S120, the information processor of the personal computer 80 judges whether the service charges for the prints or gifts being ordered by the user 16 can be covered by the remaining balance. Specifically, it judges whether service charges calculated based on the order information received from the user's 16 personal computer 80 and the image service usage information read out of the account database 92 are within the amount paid by the media preparation service client 12.

In the next S122, if it is judged that the order amount is invalid (the order amount exceeds the budget), the processing returns to S116. If it is judged that the order amount is valid (the order amount is within the budget), the processing goes to S124 (Send order to server), where the order information is sent to the server 90.

When the information processor of the personal computer 80 finishes sending the order information to the server 90 in S124, it goes to S126, where it finishes the service ordering routine.

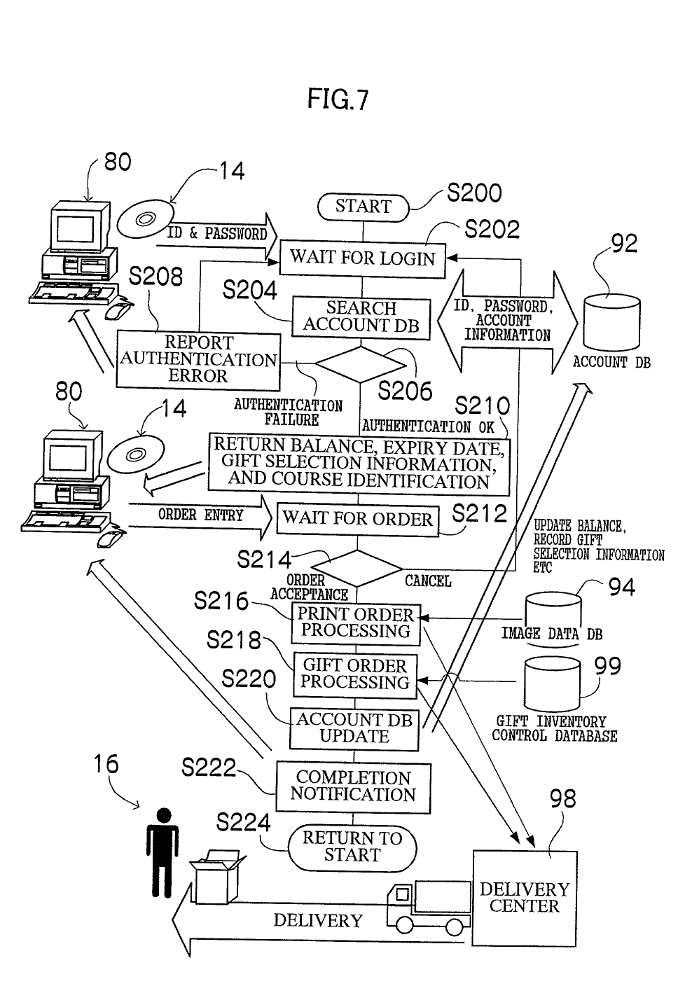

FIG. 7 shows a flowchart of service order processing performed by the server 90 of the service provider 18.

As shown in the drawing, after the server 90 starts service order processing in S200 (Start), the processing performed by the information processor of the server 90 goes to S202 (Wait for login).

In S202, the information processor waits for login information to be received from the personal computer 80 of a user 16. When a login request, ID, and password are received from the personal computer 80 of a user 16, the processing performed by the information processor of the server 90 goes to S204 (Search account DB) and reads the password associated with the received ID from the account database 92. In S206, the information processor determines authenticity of the password received from the personal computer 80 by checking it against the password read from the account database 92.

If the password received from the personal computer 80 does not match the password read from the account database 92, the information processor judges that authentication was unsuccessful and goes to S208 (Report authentication error), where it notifies the personal computer 80 of the authentication failure. When the information about the authentication failure has been transmitted, the processing returns to S202.

If the password received from the personal computer 80 matches the password read from the account database 92, the information processor judges that authentication was successful and goes to S210 (Return balance, expiry date, gift selection information, and course identification), where it returns information about the successful authentication to the personal computer 80. Then, the information processor goes to S212 (Wait for order), where it waits for order information to be obtained from the personal computer 80 of the user 16.

In S214, the information processor determines whether to accept the order, based on the order information received from the personal computer 80. If information about intention to cancel the order is received from the personal computer 80, the information processor terminates order processing and returns to S202. If order information such as information about images desired to be printed, a print order information, and gift order information are received from the personal computer 80, the processing goes to S216 (Print order processing) and subsequent steps.

In S216, based on the order information received from the personal computer 80, the information processor searches the image database 94 and reads the image file of the user 16 who placed the order. Then, the information processor produces prints according to the order and asks the means of delivery 98 to deliver the commodities.

In S218 (Gift order processing), based on the gift order information received from the personal computer 80, the information processor searches a gift inventory control database 99 and performs sales processing of appropriate commodities for the appropriate user. The gift order information may contain information about a delivery order for the appropriate commodities. In the sales processing, the information processor reads the names of the appropriate commodities from the gift inventory control database 99 based on the received order information and user-specific identification information and outputs delivery service instructions, thereby asking the means of delivery 98 to deliver the appropriate commodities to the appropriate user.

The gift inventory control database 99 (commodity database) stores the IDs of the recording media 14 (media IDs) which contain commodity lists and catalogs, by associating them with the names of the commodities recorded in the recording media.

When it finishes giving the instructions concerning delivery of the commodities to the user 16, the information processor of the server 90 goes to S220 (Account DB update) and reads image service usage information (balance information, gift selection information, etc.) of the user to whom the password belongs from the account database 92. Then the server 90 edits usage information read from the account database 92 by adding service charges calculated based on order information, the image service usage information, and gift order information and records the new usage information in the account database 92 (Information update).

Next, in S222 (Completion notification), the server 90 sends information to the effect that commodity delivery is complete to the personal computer 80 of the user 16 who placed the order for the commodities. The processing goes to S224 (Return to start), finishes the commodity service order processing routine, and returns to S200 again.

In this way, users 16 can order prints within the limit of a preset amount by selecting desired images taken at the wedding. Since a gift list of appropriate rank is displayed according to passwords in an ordering screen on the display device of the personal computer 80, users 16 can order gifts via the server 90 of the service provider 18 and receive the gifts by mail together with pictures, eliminating the need to bring bulky gifts back home from the wedding.

Also, the present invention is not limited to sales of gifts presented to wedding guests or images related to a wedding, which have been described above. It can also be used for an online ordering method in which a media preparation service client presents a CD-ROM containing an electronic commodity-catalog to each user, who later places an order online for desired commodities selected from the commodity catalog. In this case, the service provider's server compares the service usage information for the user and the cost paid by the media preparation service client and allows the user to order commodities or their delivery service any number of times as long as the cost is not exceeded. Also, although with conventional sales methods based on gift catalogs, a user can select only one commodity, the online ordering method of the present invention provides the advantage of being able to purchase a plurality of commodities as long as the cost paid by the media preparation service client is not exceeded. Furthermore, there is an advantage that it is possible to purchase the commodities any number of times if it is within a predetermined effective period. A method has been known according to which a plurality of limited-function software products are recorded in a CD-ROM and only the user who pays for a desired product selected from them is informed of a password for removing functional limitations on the given product. The present invention is advantageous in that users can purchase any number of commodities such as software products contained in a prepaid CD-ROM or the like as long as the cost paid by the media preparation service client is not exceeded.

As described above, the online ordering method according to the present invention allows the user to place orders for services such as printing of images contained in the recording medium with a service provider via a communications network because it includes a step in which the service provider's server receives information about image service, information to the effect that the cost of the image service will be paid, identification information of the recording medium, and the images to be handled by the service, from the media preparation service client who has made the request to prepare the recording medium; a step in which the service provider's server records the received information about service and identification information of the recording medium in the account database by associating them each other; a step in which the service provider's server records the received identification information of the recording medium and the images to be handled by the service in an image database by associating them each other; a step in which the user's communications terminal transmits the user-specific identification information to the service provider's server; a step in which the user's communications terminal transmits order information about a service such as printing of images recorded in the recording medium or the like to the service provider's server; a step in which the service provider's server receives the user-specific identification information from the user's communications terminal; a step in which the service provider's server receives the order information from the user's communications terminal; a step in which the service provider's server reads from the account database the image service usage information for the user who corresponds to the received identification information; and a step in which the service provider's server reads an appropriate image from the image database and provides image service to the appropriate user based on the received order information if it judges that service charges calculated based on the received order information and the image service usage information are within the amount paid by the media preparation service client.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An online ordering method in which a user receives a recording medium containing images and user-specific identification information from a media preparation service client and the user places an order for a service such as printing of images contained in the recording medium with a service provider via a communications network, wherein:
the online ordering method uses an online ordering system which comprises:
the recording medium containing images and received by the user together with the user-specific identification information from the media preparation service client;
a user's communications terminal capable of transmitting and receiving information to/from an image service provider's server via the communications network; and
the service provider's server which is capable of transmitting and receiving information to/from the user's communications terminal via the communications network, is equipped with an account database that records the user-specific identification information and image service usage information by associating them each other, and provides an image service, and
the online ordering method comprises:
a step in which the service provider's server receives information about image service, information to the effect that the cost of the image service will be paid, identification information of the recording medium, and the images to be handled by the service, from the media preparation service client who has made the request to prepare the recording medium;
a step in which the service provider's server records the received information about service and identification information of the recording medium in the account database by associating them each other;
a step in which the service provider's server records the received identification information of the recording medium and the images to be handled by the service in an image database by associating them each other;
a step in which the user's communications terminal transmits the user-specific identification information to the service provider's server;
a step in which the user's communications terminal transmits order information about a service such as printing of images recorded in the recording medium or the like to the service provider's server;
a step in which the service provider's server receives the user-specific identification information from the user's communications terminal;
a step in which the service provider's server receives the order information from the user's communications terminal;
a step in which the service provider's server reads from the account database the image service usage information for the user who corresponds to the received identification information; and
a step in which the service provider's server reads an appropriate image from the image database and provides image service to the appropriate user based on the received order information if it judges that service charges calculated based on the received order information and the image service usage information are within the amount paid by the media preparation service client.

2. The online ordering method according to claim 1, wherein:
the communications terminal comprises a device which reads images or other information recorded in the recording medium, a display device which displays images or other information for the user, and an input device for the user to enter order information; and
the online ordering method further comprises:
a step in which the communication terminal reads images recorded on the recording medium to display it on the display device;
a step in which the user enters order information about a service such as printing of images in the input device of the communications terminal based on images or other information displayed on the display device; and
a step in which the communications terminal transmits the entered order information to the service provider's server.

3. The online ordering method according to claim 1, wherein:
the communications terminal comprises a device which reads service information corresponding to service of images recorded in the recording medium; and
the online ordering method further comprises:
a step in which the communications terminal reads service information recorded in the recording medium and transmits it to the service provider's server;
a step in which the service provider's server receives the service information from the communications terminal; and
a step in which the service provider's server provides image service to the user based on the received service information.

4. The online ordering method according to claim 1, wherein:
the recording medium contains at least one of application software which displays images recorded in the recording medium and application software for placing orders for services related to the images recorded in the recording medium; and
the communications terminal comprises a step of at least one of displaying images and placing orders for services related to images based on the application software.

5. An online ordering method in which a user receives a recording medium containing images and user-specific identification information from a media preparation service client and the user places an order for a service such as printing of images contained in the recording medium with a service provider via a communications network, wherein:
the online ordering method uses an online ordering system which comprises:
the recording medium containing images and received by the user together with the user-specific identification information from the media preparation service client;
a user's communications terminal capable of transmitting and receiving information to/from an image service provider's communications terminal via the communications network; and
the service provider's server which is capable of transmitting and receiving information to/from the user's communications terminal via the communications network, is equipped with an account database that records the user-specific identification information and image service usage information by associating them each other, and provides an image service, and
the online ordering method comprises:
a step in which the user's communications terminal transmits the user-specific identification information to the service provider's server;
a step in which the user's communications terminal transmits order information about a service such as printing of images recorded in the recording medium or the like to the service provider's server;
a step in which the service provider's server receives the user-specific identification information from the user's communications terminal;
a step in which the service provider's server receives the order information from the user's communications terminal;
a step in which the service provider's server reads from the account database the image service usage information for the user who corresponds to the received identification information; and
a step in which the service provider's server overwrites the user's image service usage information based on the received order information;
a step in which the service provider's server provides service to the appropriate user based on the received order information; and
a step in which, based on the overwritten service usage information, the service provider's server transmits billing information concerning usage charges to one of the communications terminal on the side of the media preparation service client who has made the request to prepare the recording medium and the communications terminal on the side of the user.

6. The online ordering method according to claim 5, wherein:
the communications terminal comprises a device which reads images or other information recorded in the recording medium, a display device which displays images or other information for the user, and an input device for the user to enter order information; and
the online ordering method further comprises:
a step in which the communication terminal reads images recorded on the recording medium to display it on the display device;
a step in which the user enters order information about a service such as printing of images in the input device of the communications terminal based on images or other information displayed on the display device; and
a step in which the communications terminal transmits the entered order information to the service provider's server.

7. The online ordering method according to claim 5, wherein:
the communications terminal comprises a device which reads service information corresponding to service of images recorded in the recording medium; and
the online ordering method further comprises:
a step in which the communications terminal reads service information recorded in the recording medium and transmits it to the service provider's server;
a step in which the service provider's server receives the service information from the communications terminal; and
a step in which the service provider's server provides image service to the user based on the received service information.

8. The online ordering method according to claim 5, wherein:
the recording medium contains at least one of application software which displays images recorded in the recording medium and application software for placing orders for services related to the images recorded in the recording medium; and
the communications terminal comprises a step of at least one of displaying images and placing orders for services related to images based on the application software.

9. A service-provider-side online ordering method in which a user receives a recording medium containing images and user-specific identification information from a media preparation service client and the user places an order for image service such as a print service and delivery service of images contained in the recording medium with a service provider via a communications network, the method comprising the steps of:
receiving image service usage information, information to an effect that a cost of the image service will be paid, the user-specific identification information, and the images to be handled by the service, from the media preparation service client who has made the request to prepare the recording medium;
storing the received image service usage information and user-specific identification information in an account database by associating them each other;
storing the received user-specific identification information and the images to be handled by the service in an image database by associating them each other;
receiving the user-specific identification information from the user's communications terminal;
receiving order information about intention to order a service related to images recorded in the recording medium from the user's communications terminal;
reading from the account database the image service usage information for the user who corresponds to the user-specific identification information received from the user's communications terminal;
reading an appropriate image from the image database and providing image service such as a print service and delivery service to the appropriate user based on the received order information and user-specific identification information if it is judged that service charges calculated based on the received order information and the image service usage information are within the amount paid by the media preparation service client.

10. A service-provider-side online ordering method in which a user receives a recording medium containing images and user-specific identification information from a media preparation service client and the user places an order for image service such as a print service and delivery service of images contained in the recording medium with a service provider via a communications network, the method comprising the steps of:
receiving the user-specific identification information from the user's communications terminal;
receiving order information about intention to order a service related to images recorded in the recording medium from the user's communications terminal;
reading image service usage information for the user who corresponds to the received user-specific identification information, from an account database which records the user-specific identification information and image service usage information by associating them each other;
overwriting the image service usage information for the appropriate user based on the received order information and user-specific identification information;
providing image service such as a print service and delivery service to the appropriate user based on the received order information and user-specific identification information; and
transmitting billing information concerning usage charges to one of the communications terminal on the side of the media preparation service client who has made the request to prepare the recording medium and the communications terminal on the side of the user, based on the overwritten service usage information.

11. A service-provider-side online ordering method in which a user receives a recording medium containing commodity names and user-specific identification information from a media preparation service client and the user places an order for delivery service of commodities contained in the recording medium with a service provider, wherein the method comprising the steps of:
receiving information about the usage of commodity delivery service, information to the effect that the cost of the delivery service will be paid, and the user-specific identification information from the media preparation service client who has made the request to prepare the recording medium;
storing the received information about usage of the commodity delivery service and user-specific identification information in an account database by associating them each other;
storing the received user-specific identification information and the names of the commodities to be handled by the delivery service in a commodity database by associating them each other;
receiving the user-specific identification information from the user's communications terminal;
receiving order information about intention to order delivery of commodities recorded in the recording medium from the user's communications terminal;
reading from the account database the commodity delivery service usage information for the user who corresponds to the user-specific identification information received from the user's communications terminal; and
outputting instructions to read appropriate commodity names from the commodity database and provide commodity delivery service to the appropriate user based on the received order information and user-specific identification information if it is judged that service charges calculated based on the received order information and the commodity delivery service usage information are within the amount paid by the media preparation service client.

12. A service-provider-side online ordering method in which a user receives a recording medium containing commodity names and user-specific identification information from a media preparation service client and the user places an order for delivery service of commodities contained in the recording medium with a service provider, wherein the method comprising the steps of:
receiving the user-specific identification information from the user's communications terminal;
receiving order information about intention to order delivery of commodities recorded in the recording medium from the user's communications terminal;
reading the commodity delivery service usage information for the user who corresponds to the received user-specific identification information, from an account database which records the user-specific identification information and commodity delivery service usage information by associating them each other;
overwriting the commodity delivery service usage information for the appropriate user based on the received order information and user-specific identification information;
outputting instructions to provide commodity delivery service to the appropriate user based on the received order information and user-specific identification information; and
transmitting billing information concerning usage charges to one of the communications terminal on the side of the media preparation service client who has made the request to prepare the recording medium and the communications terminal on the side of the user, based on the overwritten delivery service usage information.
